(19) United States
(12) Patent Application Publication
(10) Pub. No.: US 2011/0172010 A1
(43) Pub. Date: Jul. 14, 2011

(54) INFORMATION PROCESSING DEVICE, INFORMATION PROCESSING DEVICE CONTROL METHOD, PROGRAM, AND INFORMATION STORAGE MEDIUM

(75) Inventor: Takahiro Sakiyama, Tokyo (JP)

(73) Assignee: KONAMI DIGITAL ENTERTAINMENT CO., LTD., Minato-ku, Tokyo (JP)

(21) Appl. No.: 13/121,058

(22) PCT Filed: Jun. 3, 2009
(86) PCT No.: PCT/JP2009/060179

§ 371 Date: Apr. 4, 2011

(30) Foreign Application Priority Data
Sep. 26, 2008 (JP) 2008-249149

(51) Int. Cl. A63F 13/00

(52) U.S. Cl. 463/31

(57) ABSTRACT

To provide an information processing device capable of improving operability thereof for a user, the information processing device executing processing based on a result of judging whether or not the user has specified a position in a reference region of a screen. Specified-position acquiring means (86) acquires the position specified by the user. Judgment means (88) judges whether or not the specified position is included in the reference region set in the screen. Execution means (90) executes processing based on a result of the judging made by the judgment means (88). Recording means (92) records, in previously-specified-position data storage means, previously-specified-position data regarding a previously-specified position judged to be included in the reference region. Reference region changing means (94) changes the reference region based on the previously-specified-position data.

### TECHNICAL FIELD

The present invention relates to an information processing device, a method of controlling an information processing device, a program, and an information storage medium.

### BACKGROUND ART

There is known an information processing device which executes processing based on a result of judging whether or not a user has pointed to a position in a reference region of a screen.

For example, there is known an information processing device which employs so-called software keyboard technology. With this information processing device, a plurality of reference regions corresponding to a plurality of characters (or plurality of character groups) are set on a screen. Then, a string input by a user is determined based on a result of judging whether or not the user has pointed to a position in any one of the plurality of reference regions.

Further, for example, there is known an information processing device which executes processing associated with an option selected by a user from among a plurality of options. With this information processing device, a plurality of reference regions corresponding to the plurality of options (or plurality of option groups) are set on a screen. Then, the option selected by the user is determined based on a result of judging whether or not the user has pointed to a position in any one of the plurality of reference regions.

### Prior Art Document

### Patent Document

Patent Document 1: JP 2006-55294 A

### DISCLOSURE OF THE INVENTION

### Problems To Be Solved By the Invention

For the information processing devices described above, it is strongly desired that operability thereof be improved for the user so that the user can point to a desired symbol (symbol group) or an option (option group) with greater ease, for example.

The present invention has been made in view of the above-mentioned problem, and it is an object of the present invention to provide an information processing device, a method of controlling an information processing device, a program, and an information storage medium capable of improving operability of the information processing device for a user, the information processing device executing processing based on a result of judging whether or not a user has pointed to a position in a reference region of a screen.

### Means For Solving the Problems

In order to solve the above-mentioned problem, an information processing device according to the present invention includes: specified-position acquiring means for acquiring a position specified by a user; judgment means for judging whether or not the specified position is included in a reference region set on a screen; execution means for executing processing based on a result of the judging made by the judgment means; recording means for recording, in previously-specified-position data storage means, previously-specified-position data regarding a previously-specified position judged to be included in the reference region; and reference region changing means for changing the reference region based on the previously-specified-position data.

Further, a method of controlling an information processing device according to the present invention includes: a specified-position acquiring step of acquiring a position specified by a user; a judgment step of judging whether or not the specified position is included in a reference region set on a screen; an execution step of executing processing based on a result of the judging made in the judgment step; a recording step of recording, in previously-specified-position data storage means, previously-specified-position data regarding a previously-specified position judged to be included in the reference region; and a reference region changing step of changing the reference region based on the previously-specified-position data.

Further, a program according to the present invention is a program for causing a computer to function as: specified-position acquiring means for acquiring a position specified by a user; judgment means for judging whether or not the specified position is included in a reference region set on a screen; execution means for executing processing based on a result of the judging made by the judgment means; recording means for recording, in previously-specified-position data storage means, previously-specified-position data regarding a previously-specified position judged to be included in the reference region; and reference region changing means for changing the reference region based on the previously-specified-position data.

Further, an information storage medium according to the present invention is a computer-readable information storage medium storing the above-mentioned program.

According to the present invention, it becomes possible to improve, for the user, operability of the information processing device which executes processing based on a result of judging whether or not the user has specified a position in a reference region of the screen.

Further, according to an aspect of the present invention, the previously-specified-position data may include data regarding which one of a plurality of partial regions set in the reference region includes the previously-specified position.

Further, according to an aspect of the present invention, the judgment means may judge whether or not the specified position is included in any one of a plurality of the reference regions set on the screen. The previously-specified-position data may be stored in association with a combination of reference regions. The recording means may update, in a case where a second specified position is acquired after a first specified position is acquired, previously-specified-position data stored in association with a combination of a reference region including the first specified position and a reference region including the second specified position, based on the second specified position. The reference region changing means may change, in a case where a first reference region is changed, the first reference region based on previously-specified-position data stored in association with a combination of the first reference region and a second reference region including a specified position acquired immediately before.

Further, according to an aspect of the present invention, the information processing device may include reference symbol sequence storage means for storing a reference symbol sequence including one or a plurality of symbols. A plurality of the reference regions each corresponding to a symbol or a symbol group may be set on the screen. The judgment means may judge whether or not the specified position is included in any one of the plurality of the reference regions. The execution means may include means for determining, based on a result of the judging made by the judgment means, a symbol sequence input by the user. The reference region changing means may change, based on the previously-specified-position data, the reference region corresponding to a symbol included in the reference symbol sequence or the reference region corresponding to the symbol group to which a symbol included in the reference symbol sequence belongs.

Note that in this description, the claims, the drawings, and the abstract, “symbols” means broadly-defined symbols, and “symbols” include, for example, characters, signs (narrowly-defined symbols), pictograms, and the like. Further, “symbol sequence” also includes a symbol sequence consisting of one symbol (that is, a single symbol).

Further, according to an aspect of the present invention, in a case where the user inputs an i-th symbol (i: integer equal to or larger than 1), the reference region changing means may change, based on the previously-specified-position data, the reference region corresponding to the i-th symbol of the reference symbol sequence or the reference region corresponding to the symbol group to which the i-th symbol of the reference symbol sequence belongs.

Further, according to an aspect of the present invention, the information processing device may include reference option storage means for storing a reference option. A plurality of the reference regions each corresponding to an option or an option group may be set on the screen. The judgment means may judge whether or not the specified position is included in any one of the plurality of reference regions. The execution means may include means for determining, based on a result of the judging made by the judgment means, an option selected by the user. The reference region changing means may change, based on the previously-specified-position data, the reference region corresponding to an option serving as the reference option or the reference region corresponding to the option group to which the option serving as the reference option belongs.

### BRIEF DESCRIPTION OF THE DRAWINGS

FIG. 1 is a perspective view illustrating an outer appearance of a game device according to first and second embodiments.

FIG. 2 is a diagram illustrating an outer appearance of the game device according to the first and second embodiments.

FIG. 3 is a diagram illustrating a hardware configuration of the game device according to the first and second embodiments.

FIG. 4 is a diagram illustrating an example of an answer screen according to the first embodiment.

FIG. 5 is a diagram illustrating an example of key regions.

FIG. 6 is a functional block diagram of the game device according to the first embodiment.

FIG. 7 is a diagram illustrating an example of history data according to the first embodiment.

FIG. 8 is a diagram illustrating an example of a plurality of partial regions set in a character key region.

FIG. 9 is a flow chart illustrating processing to be executed by the game device according to the first embodiment.

FIG. 10 is a flow chart illustrating the processing to be executed by the game device according to the first embodiment.

FIG. 11 is a flow chart illustrating the processing to be executed by the game device according to the first embodiment.

FIG. 12 is a diagram illustrating an example of change control data.

FIG. 13 is a diagram for describing an example of a method of changing the character key region.

FIG. 14 is a diagram illustrating another example of the history data according to the first embodiment.

FIG. 15 is a diagram illustrating an example of an answer screen according to the second embodiment.

FIG. 16 is a diagram illustrating an example of option regions.

FIG. 17 is a functional block diagram of the game device according to the second embodiment.

FIG. 18 is a diagram illustrating an example of history data according to the second embodiment.

FIG. 19 is a flow chart illustrating processing to be executed by the game device according to the second embodiment.

FIG. 20 is a diagram for describing another example of the method of changing the character key region.

### BEST MODE FOR CARRYING OUT THE INVENTION

Hereinbelow, detailed description is given of examples of embodiments of the present invention, with reference to the drawings. Here, description is given of a case where the present invention is applied to a game device which is one aspect of an information processing device. Further, description is herein given of a case where the game device according to the embodiments of the present invention is implemented using a portable game machine. Note that the game device may also be implemented using a stationary game machine (consumer game machine), an arcade game machine, a mobile phone, a personal digital assistant (PDA), a personal computer, or the like. Further, the present invention is also applicable to an information processing device other than the game device.

### First Embodiment

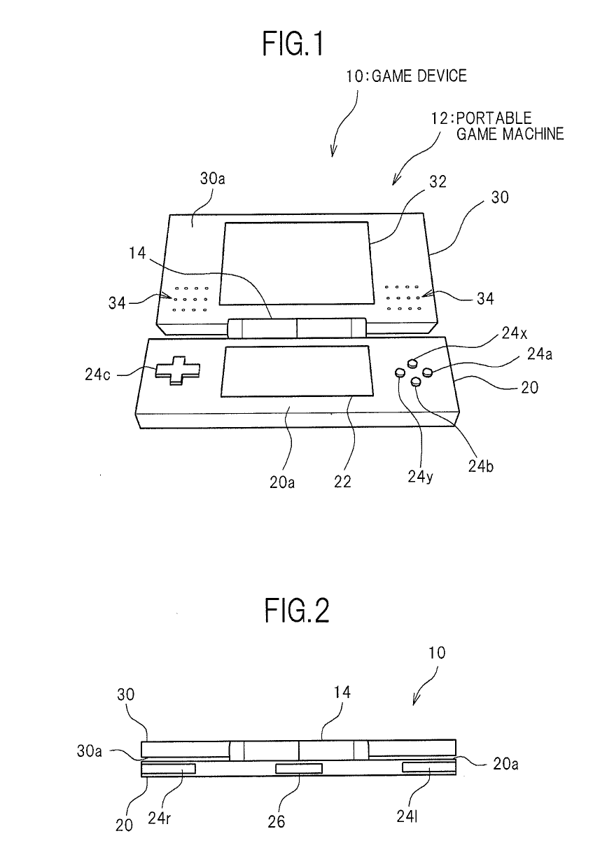

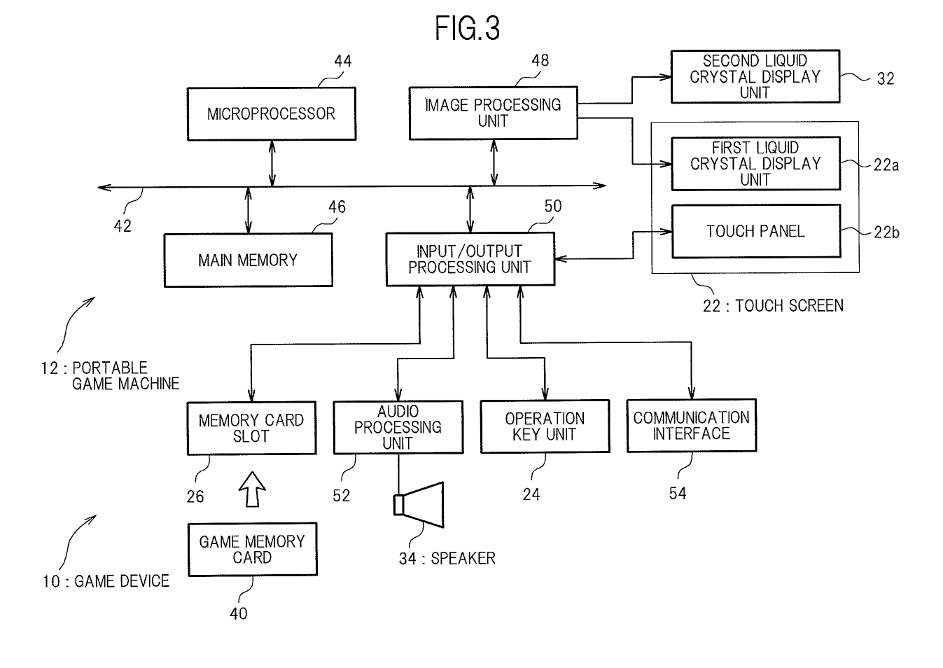

FIG. 1 and FIG. 2 each illustrate an outer appearance of a game device 10 (portable game machine 12) according to a first embodiment of the present invention. FIG. 3 illustrates a hardware configuration of the game device 10 according to this embodiment.

FIG. 1 is a perspective view illustrating an appearance of the game device 10 when viewed from the front. As illustrated in FIG. 1, the game device 10 includes a first casing 20 and a second casing 30. The first casing 20 and the second casing 30 are coupled to each other by means of a hinge part 14. A touch screen 22, a cross-shaped button 24c, and buttons 24a, 24b, 24x, and 24y are provided on a top surface 20a of the first casing 20. The touch screen 22 includes a first liquid crystal display unit 22a and a touch panel 22b placed over the first liquid crystal display unit 22a (see FIG. 3). The cross-shaped button 24c is used for an operation for specifying a direction, for example. The buttons 24a, 24b, 24x, and 24y are used for various kinds of operations. A second liquid crystal display unit 32 is provided on a top surface 30a of the second casing 30. Further, a speaker 34 is built into the second casing 30.

FIG. 2 is a rear view of the game device 10 in a folded state (state in which the top surface 20a of the first casing 20 and the top surface 30a of the second casing 30 are placed one on the other). As illustrated in FIG. 2, buttons 24l and 24r are provided at the left and right of the rear side of the first casing 20, respectively. Further, a memory card slot 26 into which a game memory card 40 (see FIG. 3) serving as an information storage medium can be inserted is provided at the center of the rear side of the first casing 20. Note that other components (not shown), such as a power switch, may also be mounted onto the game device 10.

As illustrated in FIG. 3, the game device 10 includes the touch screen 22 (first liquid crystal display unit 22a and touch panel 22b), an operation key unit 24, the memory card slot 26, the second liquid crystal display unit 32, the speaker 34, a bus 42, a microprocessor 44, a main memory 46, an image processing unit 48, an input/output processing unit 50, an audio processing unit 52, and a communication interface 54. Those components are accommodated together with a battery (not shown) in the casings, and are driven by the battery.

The microprocessor 44 executes various kinds of information processing based on an operating system stored in a ROM (not shown) and programs stored in the game memory card 40. The main memory 46 includes a RAM, for example, and a program read from the game memory card 40 is written into the main memory 46 as needed. The main memory 46 is also used as a working memory for the microprocessor 44. The bus 42 is used for exchanging addresses and data among the components of the game device 10. The microprocessor 44, the main memory 46, the image processing unit 48, and the input/output processing unit 50 are connected to one another so as to communicate data mutually via the bus 42.

The first liquid crystal display unit 22a and the second liquid crystal display unit 32 are publicly-known liquid crystal display panels. The image processing unit 48 includes a VRAM, and renders an image in the VRAM according to an instruction from the microprocessor 44. The image rendered in the VRAM is displayed on the first liquid crystal display unit 22a or the second liquid crystal display unit 32 at a predetermined time.

The input/output processing unit 50 is an interface through which the microprocessor 44 exchanges data with the touch panel 22b, the operation key unit 24, the memory card slot 26, the audio processing unit 52, and the communication interface 54. The input/output processing unit 50 is connected to the touch panel 22b, the operation key unit 24, the memory card slot 26, the audio processing unit 52, and the communication interface 54.

The operation key unit 24 is means for receiving an operation input made by a user. The operation key unit 24 includes the cross-shaped button 24c, and the buttons 24a, 24b, 24x, 24y, 24l, and 24r. The input/output processing unit 50 scans the state of each part of the operation key unit 24 at fixed intervals (for example, every 1/60^{th} of a second), and then supplies an operation signal indicating a result of the scan to the microprocessor 44 via the bus 42. The microprocessor 44 determines an operation content of the user based on the operation signal. The touch panel 22b is means for receiving an operation input made by the user as well. Specifically, the touch panel 22b receives a positional input. The touch panel 22b supplies pressed-position information according to a position pressed by the user, to the microprocessor 44 via the input/output processing unit 50. The microprocessor 44 determines the position pressed by the user based on the pressed-position information.

The memory card slot 26 reads a game program and game data stored in the game memory card 40 therefrom according to an instruction from the microprocessor 44. The game memory card 40 includes a ROM in which the game program and the game data are stored and an EEPROM in which the game data, such as save data, is stored. Note that in this description, the game memory card 40 is used to supply the game program and the game data to the game device 10, but another information storage medium, such as an optical disk, may be used as well. Alternatively, the game program and the game data may be supplied to the game device 10 from a remote location via a communication network, such as the Internet. Alternatively, the game program and the game data may be supplied to the game device 10 by using various kinds of data communications, such as infrared communication.

The audio processing unit 52 includes a sound buffer, and outputs, from the speaker 34, various kinds of audio data loaded from the game memory card 40 into the sound buffer. The communication interface 54 is an interface for establishing connection to a communication network.

On the game device 10, for example, a quiz game is executed. The quiz game is implemented through execution of a program stored in the game memory card 40.

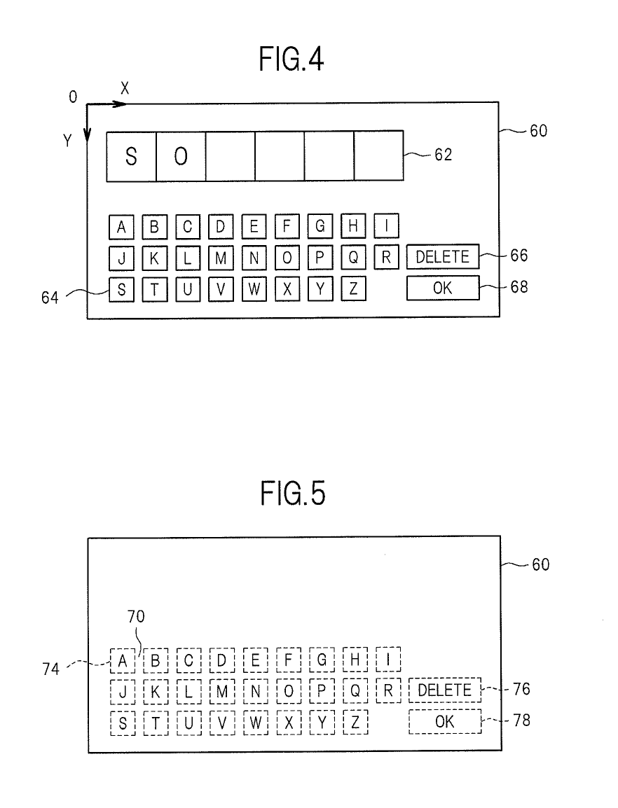

With the quiz game, a question screen showing a quiz question is displayed on the second liquid crystal display unit 32, whereas an answer screen for the user to input their answer to the quiz is displayed on the touch screen 22. FIG. 4 illustrates an example of the answer screen. As illustrated in FIG. 4, an answer screen 60 includes an answer field 62 and a plurality of key images. The answer field 62 is a field for displaying a string (answer) input by the user. Further, in this embodiment, the key images include character keys 64, a delete key 66, and an OK key 68. The character keys 64 are key images corresponding to the characters of the alphabet. The character keys 64 have the same size. The delete key 66 is a key image for deleting one character at the end of a string displayed in the answer field 62. The OK key 68 is a key image for confirming, as the answer to the quiz, the string displayed in the answer field 62.

Further, in the answer screen 60, key regions (reference regions), which are regions corresponding to the respective key images, are set. FIG. 5 illustrates an example of the key regions set in the answer screen 60. As illustrated in FIG. 5, character key regions 74 corresponding to the respective character keys 64, a delete key region 76 corresponding to the delete key 66, and an OK key region 78 corresponding to the OK key 68 are set. An invalid region 70 is provided between two adjacent key regions, and hence the key regions are set so as not to overlap each other. In the case of this embodiment, in principle, a key region coincides with a region occupied by the key image corresponding to that key region.

In a case where a position specified by the user is included in any one of the key regions, it is determined that the key image corresponding to that key region has been specified. The user specifies the character keys 64 with their thumb or finger, or a stylus pen, to thereby input a string (answer to the quiz). In a case where the user has specified the OK key 68, the string displayed in the answer field 62 is confirmed, and it is then determined whether or not the string is a correct answer.

Note that in the example illustrated in FIG. 4 and FIG. 5, the key images and the key regions have rectangular shapes, but the key images and the key regions may have a shape other than a rectangle (for example, circle).

Hereinbelow, description is given of technology for allowing the user to input characters with more ease.

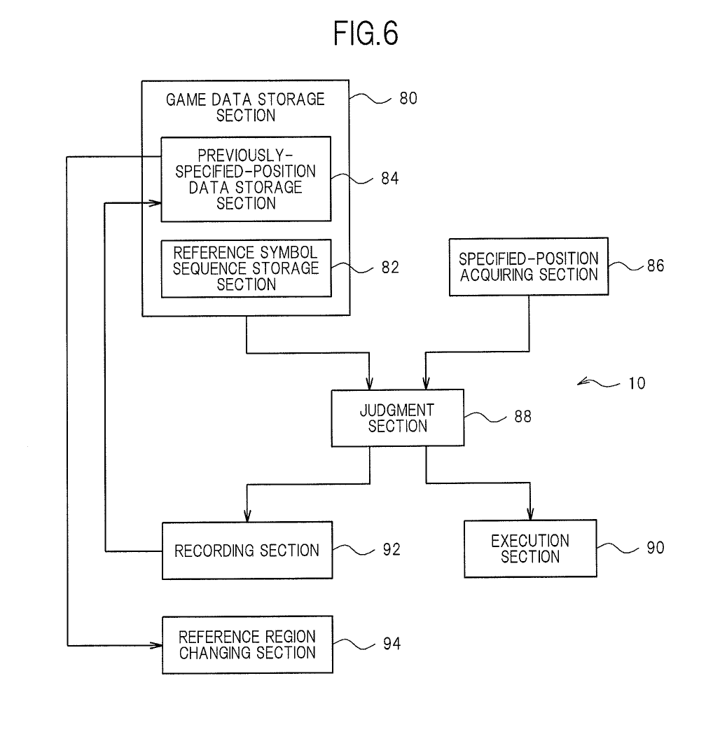

FIG. 6 is a functional block diagram illustrating functions implemented by the game device 10. As illustrated in FIG. 6, the game device 10 includes a game data storage section 80, a specified-position acquiring section 86, a judgment section 88, an execution section 90, a recording section 92, and a reference region changing section 94. The game data storage section 80 is implemented by, for example, the game memory card 40 or the main memory 46, and the other functional blocks are implemented by the microprocessor 44 executing the programs read from the game memory card 40.

The game data storage section 80 stores various kinds of data regarding the quiz game. For example, data indicating the display positions of the respective key images is stored. Further, data indicating the positions of the respective key regions (hereinbelow, referred to as “key region data”) is stored. In this embodiment, the key regions have rectangular shapes, and the widths and heights of the character key regions 74, the delete key region 76, and the OK key region 78 have fixed values. Therefore, the position of each key region can be identified by using coordinates (x, y) of one vertex (for example, upper left vertex). Accordingly, the key region data is data indicating the coordinates of the upper left vertex of each key region. Here, as illustrated in FIG. 4, the X-Y coordinate system is a coordinate system in which the upper left vertex of the answer screen 60 is set as the origin point, the lateral direction of the answer screen 60 is set as the X-axis (the rightward direction corresponds to the positive direction of the X-axis), and the longitudinal direction of the answer screen 60 is set as the Y-axis (the downward direction corresponds to the positive direction of the Y-axis). Incidentally, the position of each key region can be identified by using the coordinates of two opposing vertices (for example, upper left vertex and lower right vertex), and hence the key region data may be data indicating the coordinates of the two opposing vertices of each key region.

The game data storage section 80 includes a reference symbol sequence storage section 82. The reference symbol sequence storage section 82 stores a reference symbol sequence. For example, the reference symbol sequence storage section 82 stores a plurality of pieces of quiz data. The quiz data includes a string indicating a quiz question and a string indicating a correct answer to the quiz (hereinbelow, referred to as “correct answer string”). In this case, the correct answer string corresponds to the “reference symbol sequence”.

The game data storage section 80 also includes a previously-specified-position data storage section 84. The previously-specified-position data storage section 84 is described later.

The specified-position acquiring section 86 acquires a position specified by the user. For example, based on the pressed-position information output from the touch panel 22b, the specified-position acquiring section 86 acquires the position pressed by the user at predetermined intervals (for example, every 1/60^{th} of a second).

The judgment section 88 judges whether or not the position specified by the user, which is acquired by the specified-position acquiring section 86, is included in any one of a plurality of key regions set in the answer screen 60.

The execution section 90 executes processing based on a result of the judging made by the judgment section 88. For example, based on the result of the judging made by the judgment section 88, the execution section 90 determines a string (answer) input by the user. Then, the execution section 90 executes processing based on a result of comparison between the correct answer string and the string (answer) input by the user.

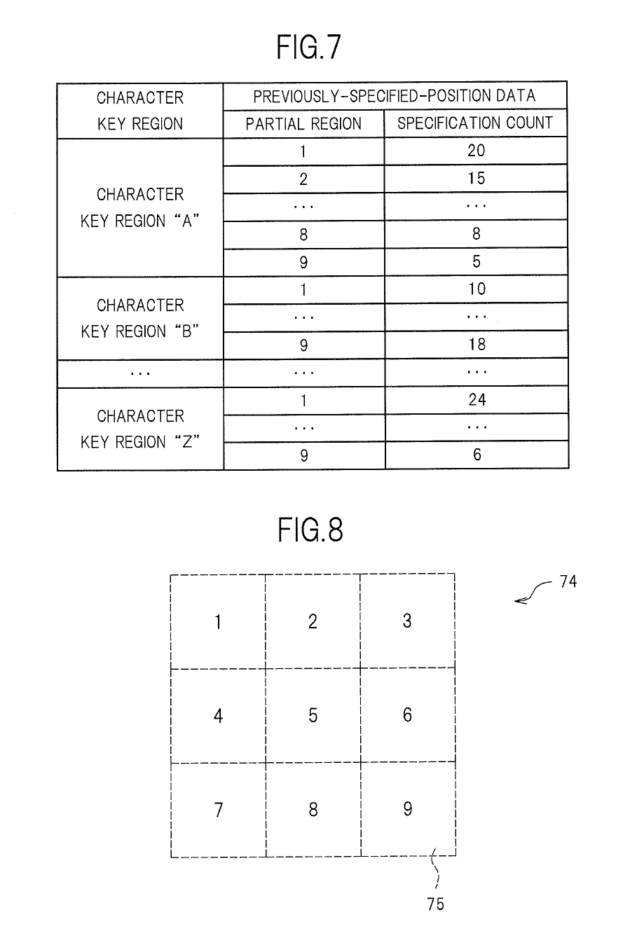

The recording section 92 records, in the previously-specified-position data storage section 84, previously-specified-position data regarding a previously-specified position judged to be included in a character key region 74. FIG. 7 illustrates an example of contents stored in the previously-specified-position data storage section 84.

In the example illustrated in FIG. 7, the previously-specified-position data is stored for each character key region 74. Further, the previously-specified-position data is a combination of a “partial region” and a “specification count”. First, description is given of the “partial region”. In the case of this embodiment, a plurality of partial regions are set in the character key region 74. FIG. 8 illustrates an example of the plurality of partial regions set in the character key region 74. In the example illustrated in FIG. 8, the character key region 74 is divided lengthwise into three and is also divided crosswise into three, thereby setting nine partial regions 75 in the character key region 74. The nine partial regions 75 have the same area. In FIG. 8, a number illustrated in each partial region 75 indicates identification information (ID) of the partial region 75. Further, the “specification count” indicates a total number of times a player has specified a position in a partial region 75 of a character key region 74, which is identified by the “character key region” and the “partial region”. In other words, the “specification count” indicates a total number of times a position specified by the user has been judged to be included in the partial region 75 of the character key region 74, which is identified by the “character key region” and the “partial region”.

Note that the number of the partial regions 75 set in each character key region 74 is not limited to nine. For example, each character key region 74 may be divided into four, sixteen, or twenty-five, thereby setting four, sixteen, or twenty-five partial regions 75 in each character key region 74.

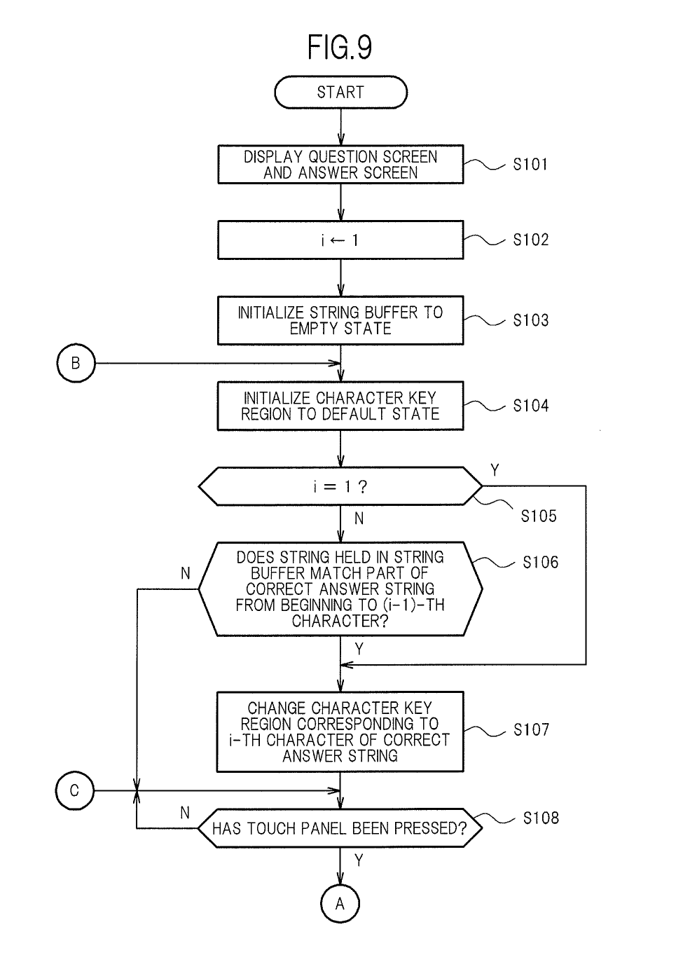

The reference region changing section 94 changes the character key region 74 based on the previously-specified-position data. For example, the reference region changing section 94 changes the position, the area, the shape, or the like of the character key region 74. Detailed description is given later (see S107 of FIG. 9).

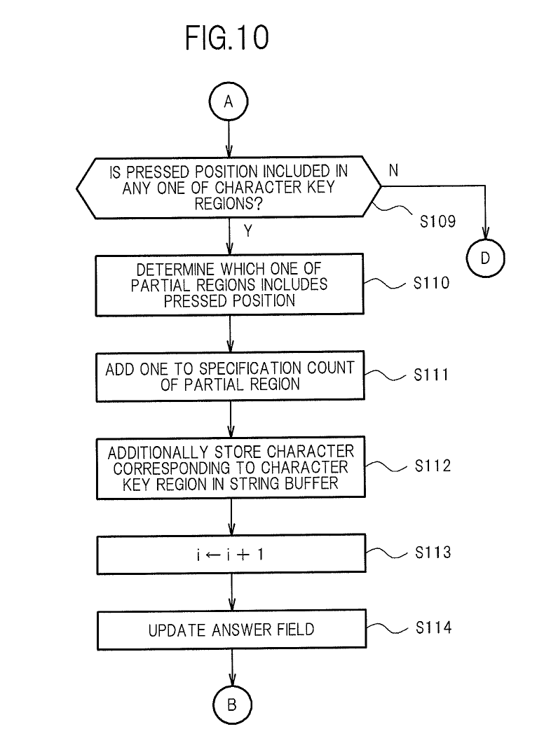

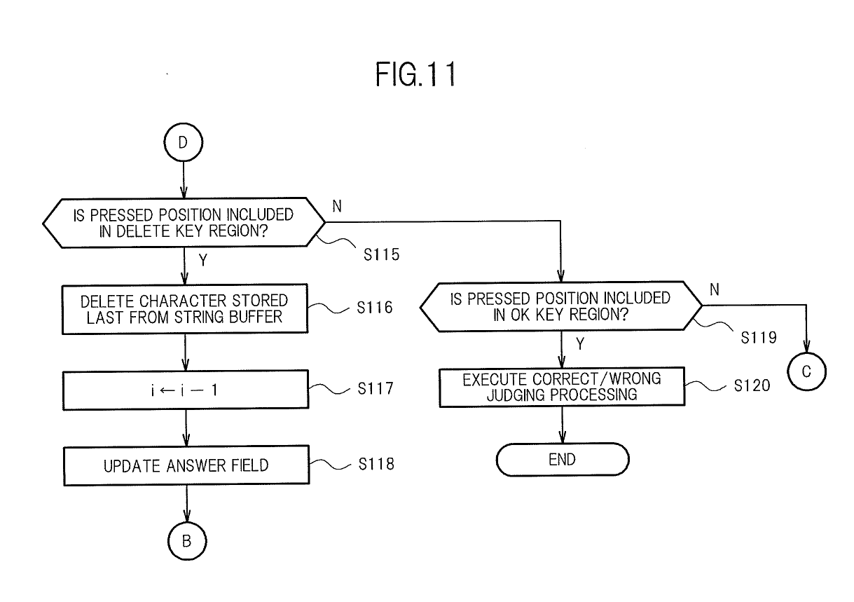

Next, description is given of processing to be executed by the game device 10. FIG. 9, FIG. 10, and FIG. 11 are flow charts illustrating the processing to be executed by the game device 10. The microprocessor 44 executes the processing illustrated in FIGS. 9 to 11 according to the program read from the game memory card 40.

As illustrated in FIG. 9, first, the microprocessor 44 displays a question screen on the second liquid crystal display unit 32, and displays the answer screen 60 on the touch screen 22 (S101). Any one of the pieces is read from the plurality of pieces of quiz data stored in the game memory card 40, and a quiz question is displayed on the question screen. Further, the microprocessor 44 initializes a variable i to 1 (S102). The variable i is used for counting the number of characters input by the user.

Further, the microprocessor 44 initializes a string buffer to an empty state (S103). The string buffer is used for holding the string input by the user. Further, the microprocessor 44 initializes each character key region 74 to a default state (S104). The “default state” is, for example, the state illustrated in FIG. 5, that is, a state in which the regions showing the character keys 64 coincide with the character key regions 74. In S103, the key region data corresponding to the default state is loaded from the game memory card 40 into the main memory 46.

After that, the microprocessor 44 judges whether or not the value of the variable i is 1 (S105). Specifically, it is judged whether or not the user is attempting to input a first character. In a case where the variable i is not 1, that is, in a case where the user is attempting to input a second or subsequent character, the microprocessor 44 judges whether or not a string held in the string buffer matches a part of the correct answer string from the beginning to a (i−1)-th character (S106). Specifically, it is judged whether or not the user has already input the part of the correct answer string up to the (i−1)-th character.

After that, the microprocessor 44 (reference region changing section 94) changes the character key region 74 corresponding to an i-th character of the correct answer string (S107).

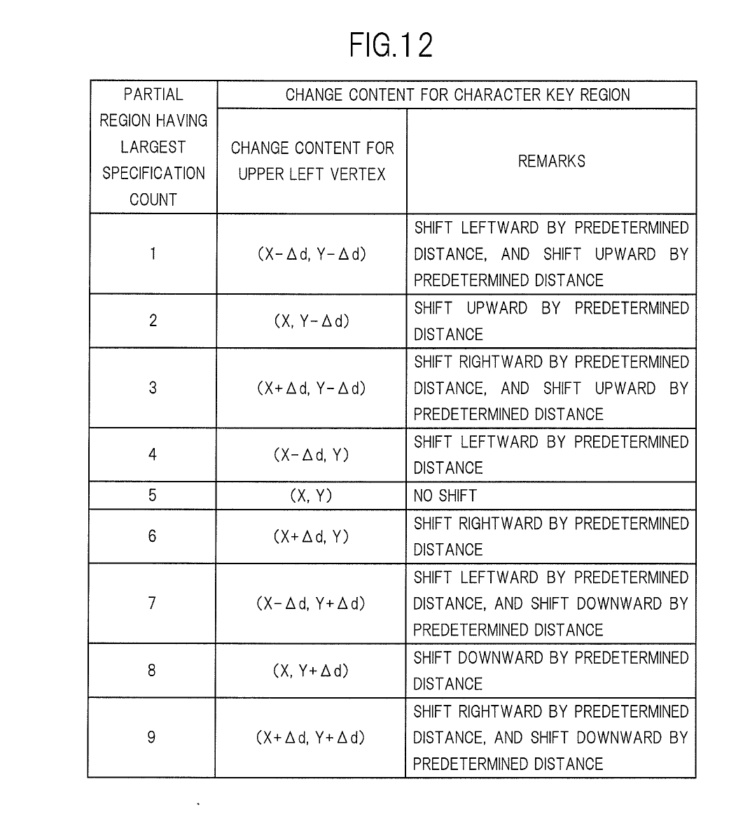

In S107, first, data regarding change control for the character key region 74 (hereinbelow, referred to as “change control data”) is read from the game memory card 40. FIG. 12 illustrates an example of the change control data. The change control data is data in which a condition regarding the previously-specified-position data stored in the previously-specified-position data storage section 84 is associated with a change content for the character key region 74. For the change control data illustrated in FIG. 12, a partial region 75 having the largest specification count is associated with a change content indicating how the character key region 74 is to be changed from the default state. Note that in FIG. 12, (X, Y) indicates the coordinates of the upper left vertex when the character key region 74 is in the default state.

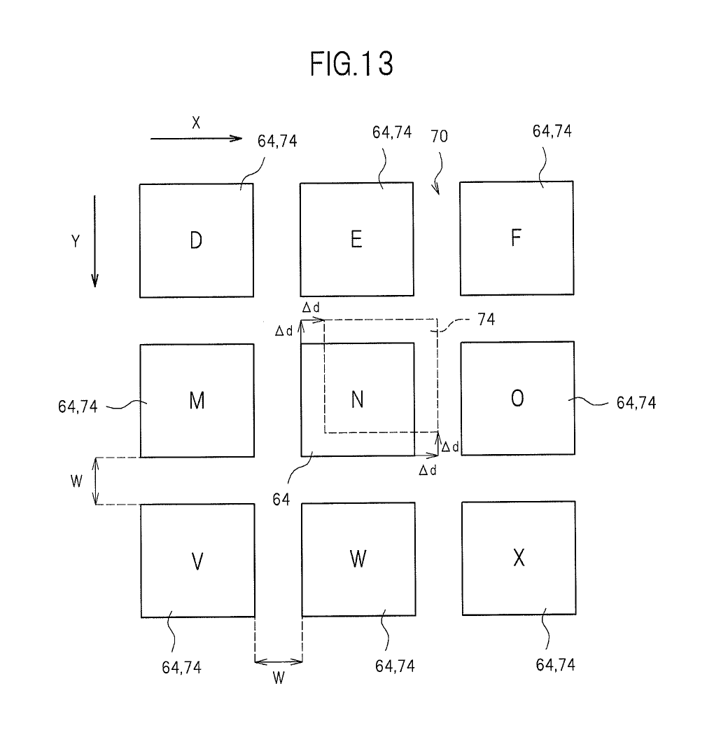

After the change control data is read, based on the change control data, the character key region 74 corresponding to the i-th character of the correct answer string is changed. Here, assume a case where the i-th character of the correct answer string is “N”, and, among the plurality of partial regions 75 of the character key region 74 corresponding to the character “N”, a partial region of “3” has the largest specification count. In this case, referring to the change control data illustrated in FIG. 12, the coordinates of the upper left vertex of the character key region 74 corresponding to the character “N” are changed to (X+Δd, Y−Δd) as illustrated in FIG. 13, for example. Specifically, the character key region 74 corresponding to the character “N” is shifted upward by a predetermined distance (Δd), and is also shifted rightward by the predetermined distance (Δd). Note that Δd is set to, for example, half a smallest width W of the invalid region 70.

When the processing of S107 is finished, the key region data obtained after the character key region 74 corresponding to the i-th character of the correct answer string is changed is stored in the main memory 46.

Note that in this embodiment, the processing of S107 is executed only in a case where the condition of S105 or S106 is satisfied. The case where the condition of S105 is satisfied is the case where the user is attempting to input the first character, whereas the case where the condition of S106 is satisfied is the case where the user has already input the part of the correct answer string up to the (i−1)-th character. In the above-mentioned case, there is a high possibility that the user is attempting to input the correct answer string. In this embodiment, only in such a case, the processing of S107 is executed, to thereby change the position of the character key region 74 corresponding to the i-th character of the correct answer string.

After that, the microprocessor 44 monitors whether or not the user has pressed the touch panel 22b (S108). In a case where the touch panel 22b has been pressed, the microprocessor 44 (specified-position acquiring section 86) acquires the pressed position as a position specified by the user. Then, as illustrated in FIG. 10, the microprocessor 44 (judgment section 88) judges whether or not the position specified by the user (pressed position) is included in any one of the character key regions 74 based on the key region data stored in the main memory 46 (S109).

In a case where the position specified by the user is included in any one of the character key regions 74, the microprocessor 44 executes processing described below. First, the microprocessor 44 (recording section 92) determines which one of the plurality of partial regions 75 of a character key region X includes the position specified by the user (S110). Note that the “character key region X” represents the character key region 74 judged in S109 to include the position specified by the user. Then, the microprocessor 44 adds one to the specification count of a partial region Y in the previously-specified-position data (see FIG. 7) of the character key region X (S111). Note that the “partial region Y” is the partial region 75 judged in S110 to include the position specified by the user.

Further, the microprocessor 44 additionally stores the character corresponding to the character key region X in the string buffer (S112). Further, the microprocessor 44 adds one to the value of the variable i (S113) and updates the answer field 62 of the answer screen 60 (S114). In other words, the string stored in the string buffer is displayed in the answer field 62.

Note that in a case where it is judged in S109 that the position specified by the user is not included in any one of the character key regions 74, the microprocessor 44 judges whether or not the position specified by the user (pressed position) is included in the delete key region 76 (S115) as illustrated in FIG. 11. In a case where the position specified by the user is included in the delete key region 76, the microprocessor 44 deletes a character stored last from the string buffer (S116), and subtracts one from the value of the variable i (S117). After that, the answer field 62 of the answer screen 60 is updated (S118), to thereby display the string stored in the string buffer in the answer field 62.

On the other hand, in a case where it is judged that the position specified by the user is not included in the delete key region 76, the microprocessor 44 judges whether or not the position specified by the user (pressed position) is included in the OK key region 78 (S119). In a case where the position specified by the user is included in the OK key region 78, the microprocessor 44 (execution section 90) executes correct/wrong judging processing (S120). Specifically, the microprocessor 44 refers to the string buffer, to thereby judge whether or not the string stored in the string buffer (answer input by the user) matches the correct answer string. In a case where the string stored in the string buffer matches the correct answer string, that is, in a case where the user's answer is correct, the microprocessor 44 adds a point to the user's score, for example. On the other hand, in a case where the string stored in the string buffer (answer input by the user) does not match the correct answer string, that is, in a case where the user's answer is incorrect, the microprocessor 44 does not add any point to the user's score.

Note that the case where it is judged that the position specified by the user is not included in the OK key region 78 is a case where the position specified by the user (pressed position) is not included in any one of the key regions. In this case, the microprocessor 44 resumes monitoring whether or not the touch panel 22b has been pressed (S108).

With the above-mentioned game device 10 according to the first embodiment, consideration is given to where the user tends to specify in each character key region 74, to thereby change the position of the character key region 74.

When the user specifies the character key region 74, the user tends to specify different positions therein depending on where the character key region 74 is located on the answer screen 60. In particular, in many cases, different positions are likely to be specified between the case of specifying a character key region 74 located in a left corner of the answer screen 60 and the case of specifying a character key region 74 located in a right corner of the answer screen 60. In this regard, with the game device 10 according to the first embodiment, the previously-specified-position data is recorded for each character key region 74, and hence, for each character key region 74, consideration is given to where the user tends to specify in the character key region 74, to thereby change the position of the character key region 74 to an optimal position. Therefore, according to the first embodiment, it becomes possible to allow the user to easily specify a position in a character key region 74. As a result, the operability can be improved for the user.

Further, with the game device 10 according to the first embodiment, when the user inputs the i-th character, only the character key region 74 corresponding to the i-th character of the correct answer string is changed. Further, as described above, with the game device 10, the character key region 74 is only changed in the case where there is a possibility that the user is attempting to input the correct answer string (that is, in the case where one of the conditions of S105 and S106 is satisfied). Therefore, with the game device 10, in the case where the user inputs the i-th character when there is a possibility that the user is attempting to input the correct answer string, the i-th character of the correct answer string is made easier for the user to input. In other words, the user who has figured out the correct answer to the quiz (user who is attempting to input a correct answer) can input the answer with greater ease. On the other hand, in a case where the user is attempting to input a string different from the correct answer string (that is, in a case where both the conditions of S105 and S106 are not satisfied), there is little need to make the i-th character of the correct answer string easier for the user to input. Rather, if the i-th character of the correct answer string is made easier for the user to input, the user who has an intention of inputting another character may input the i-th character of the correct answer string by mistake. In this regard, according to the first embodiment, such inconvenience is prevented from occurring.

Incidentally, with the game device 10 according to the first embodiment, only the position of the character key region 74 which is invisible to the user is changed, and the position of the character key 64 (key image) which is visible to the user is not changed. Therefore, there is no possibility that it will become easier for the user to figure out the correct answer to the quiz. In other words, there is no influence on the degree of difficulty of the quiz.

Here, description is given of modification examples of the first embodiment.

For example, in a period until the user finishes inputting their answer, the positions of the character key regions 74 for all the characters contained in the correct answer string may be changed based on the previously-specified-position data, regardless of what number of characters the user is to input. This configuration allows the user who has figured out the correct answer to the quiz to input the answer smoothly as well.

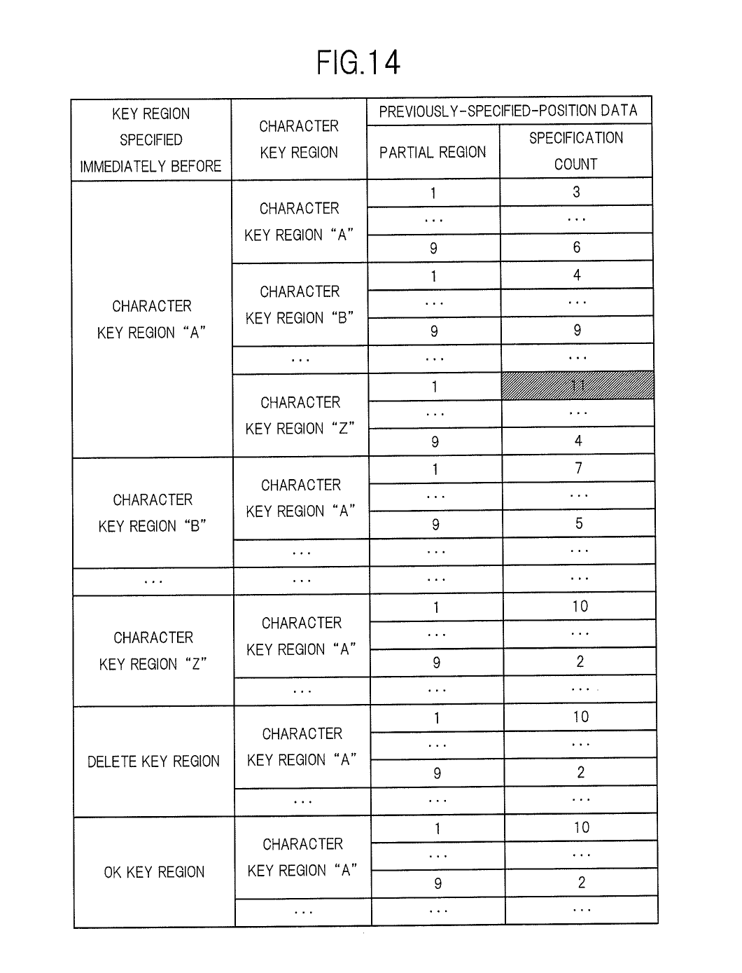

Further, for example, the previously-specified-position data may also be stored in association with a combination of a character key region and a key region specified immediately before that character key region. FIG. 14 illustrates an example of contents stored in the previously-specified-position data storage section 84 in this case. For example, in a case where the user specifies a position in the partial region “1” of the character key region 74 corresponding to a character “Z” immediately after specifying a position in the character key region 74 corresponding to a character “A”, one is added to a specification count highlighted with the hatch lines in FIG. 14.

In this modification example, in the processing of S107 of FIG. 9, first, the previously-specified-position data associated with a combination of the key region specified immediately before and the character key region 74 corresponding to the i-th character of the correct answer string is read. Then, the partial region 75 having the largest specification count is determined, to thereby apply a change of content corresponding to that partial region 75 to the character key region 74 corresponding to the i-th character of the correct answer string.

Further, for example, in the answer screen 60, key images each corresponding to a character group to which a plurality of characters belong (hereinbelow, referred to as “character group keys”) may be displayed instead of the character keys 64. Then, after the user selects any one of the character group keys, the character keys 64 for the characters belonging to a character group corresponding to that character group key may be displayed in the answer screen 60. In this modification example, key regions corresponding to the respective character group keys (hereinbelow, referred to as “character group key regions”) are set in the answer screen 60. Then, it is judged whether or not the position specified by the user is included in any one of the character group key regions, to thereby judge whether or not the user has specified a character group key. Further, based on a result of the judging, a string input by the user (answer) is acquired.

In this modification example, similarly to the case of the character key region 74, a plurality of partial regions are set in the character group key region. Then, for each character group key region, the previously-specified-position data is stored. Further, in the processing of S107 of FIG. 9, the position of the character group key region corresponding to the character group to which the i-th character of the correct answer string belongs is changed based on the previously-specified-position data. In this modification example, too, it is possible to improve the operability for the user.

Further, for example, the present invention is not limited to the case where the correct answer to the quiz is a string represented by one or a plurality of letters of the alphabet (that is, the case where the user inputs letters of the alphabet on the answer screen 60), and is also applicable to a case where the correct answer to the quiz is a string represented by characters other than the alphabet. Further, the present invention is also applicable to a case where the correct answer to the quiz is a symbol sequence represented by signs (narrowly-defined symbols), pictograms, or the like other than letters. Specifically, the present invention is applicable to a case where the user inputs, on the answer screen 60, numbers, hiragana, katakana, kanji, characters for a language (Chinese language, Korean language, or the like) other than the Japanese language, signs (narrowly-defined symbols), pictograms, or the like, for example.

### Second Embodiment

An outer appearance and a hardware configuration of a game device according to a second embodiment of the present invention are the same as in the first embodiment (FIGS. 1 to 3), and hence description thereof is omitted herein. On the game device according to this embodiment, too, a quiz game is executed based on a program stored in the game memory card 40. Note that the quiz game according to this embodiment is a quiz game in which the user selects, from among a plurality of options, one or a plurality of options which the user thinks are correct.

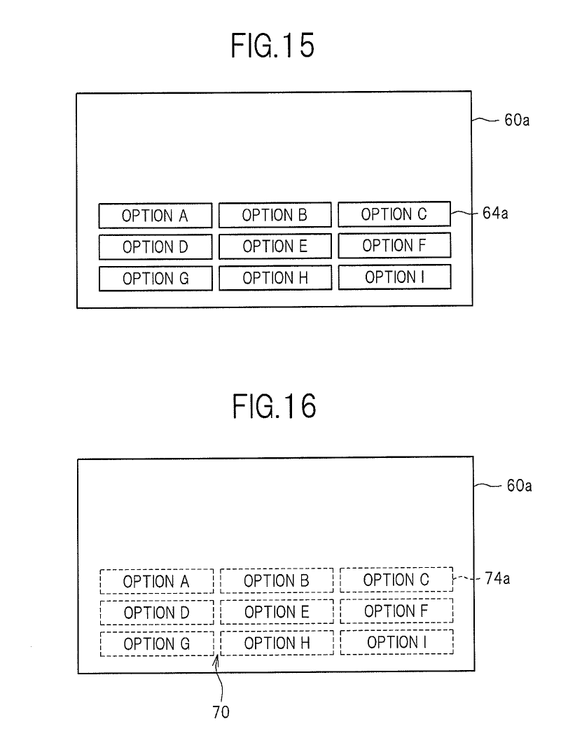

With this quiz game too, a question screen showing a quiz question is displayed on the second liquid crystal display unit 32, whereas an answer screen for the user to input their answer to the quiz is displayed on the touch screen 22. FIG. 15 illustrates an example of the answer screen. As illustrated in FIG. 15, a plurality of option images 64a are displayed on an answer screen 60a according to this embodiment. In the example illustrated in FIG. 15, the option images 64a corresponding to nine options A to I are displayed. On the answer screen 60a, the user selects any one of the options (option images 64a) to answer the quiz.

Further, option regions (reference regions), which are regions corresponding to the respective option images 64a, are set on the answer screen 60a. FIG. 16 illustrates an example of the option regions set in the answer screen 60a. As illustrated in FIG. 16, option regions 74a corresponding to the respective option images 64a are set. An invalid region 70 is provided between two adjacent option regions 74a, and the option regions 74a are set so as not to overlap each other. In this embodiment, in principle, an option region 74a coincides with a region occupied by the option image 64a corresponding to that option region 74a. In the case where the position specified by the user is included in any one of the option regions 74a, it is determined that the option (option image 64a) corresponding to that option region 74a has been selected. In this case, it is determined whether or not the option selected by the user is correct.

Note that in the example illustrated in FIG. 15 and FIG. 16, the option images 64a and the option regions 74a have rectangular shapes, but the option images 64a and the option regions 74a may have a shape other than a rectangle (for example, circle).

Hereinbelow, description is given of technology for allowing the user to select an option with greater ease.

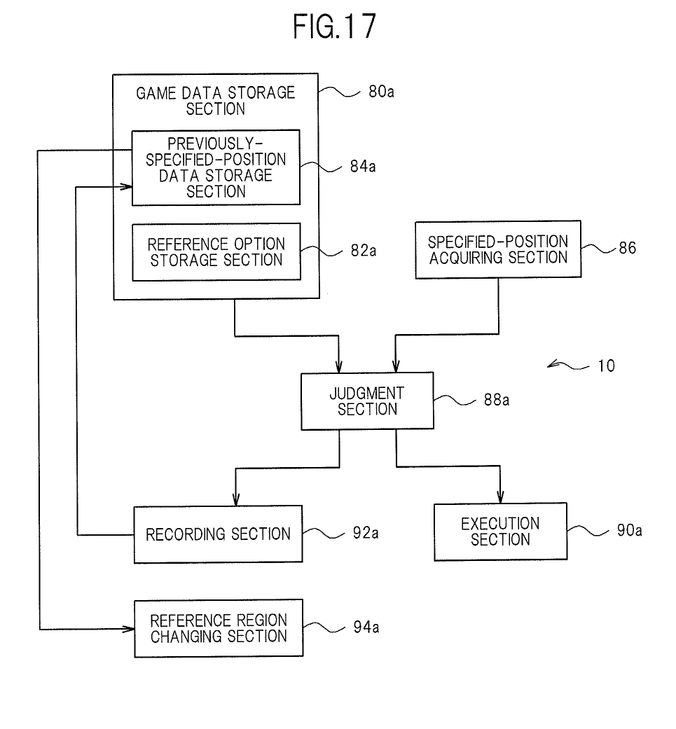

FIG. 17 is a functional block diagram illustrating, of functions implemented by the game device 10 according to the second embodiment, functions relevant to the present invention. Note that a functional block having the same function as in the first embodiment is denoted by the same reference numeral, and description thereof is omitted herein. As illustrated in FIG. 17, the game device 10 includes a game data storage section 80a, a specified-position acquiring section 86, a judgment section 88a, an execution section 90a, a recording section 92a, and a reference region changing section 94a. The game data storage section 80a is implemented by, for example, the game memory card 40 or the main memory 46, and the other functional blocks are implemented by the microprocessor 44 executing the programs read from the game memory card 40.

The game data storage section 80a stores various kinds of data regarding the quiz game. For example, data indicating the display positions of the respective option images 64a is stored. Further, data indicating the positions of the respective option regions 74a (hereinbelow, referred to as “option region data”) is stored. In this embodiment, the option regions 74a have rectangular shapes, and the widths and heights of the option regions 74a have fixed values. Therefore, the position of each option region 74a can be identified by using coordinates (x, y) of one vertex (for example, upper left vertex). Accordingly, the option region data is data indicating the coordinates of the upper left vertex of each option region 74a. Incidentally, each of the option regions 74a can be identified by using the coordinates of two opposing vertices (for example, upper left vertex and lower right vertex), and hence the option region data may be data indicating the coordinates of the two opposing vertices of each option region 74a.

The game data storage section 80a includes a reference option storage section 82a. The reference option storage section 82a stores a reference option. For example, the reference option storage section 82a stores a plurality of pieces of quiz data. The quiz data includes a string indicating a quiz question, a plurality of options to be presented to the user, and an option which is the correct answer to the quiz. In this case, the option which is the correct answer to the quiz corresponds to the “reference option”.

The game data storage section 80a also includes a previously-specified-position data storage section 84a. The previously-specified-position data storage section 84a is described later.

The judgment section 88a judges whether or not the position specified by the user is included in any one of a plurality of option regions 74a. The execution section 90a executes processing based on a result of the judging made by the judgment section 88a. For example, based on the result of the judging made by the judgment section 88a, the execution section 90a determines an option (answer) selected by the user. Then, the execution section 90a executes processing based on a result of comparison between the option of the correct answer and the option (answer) selected by the user.

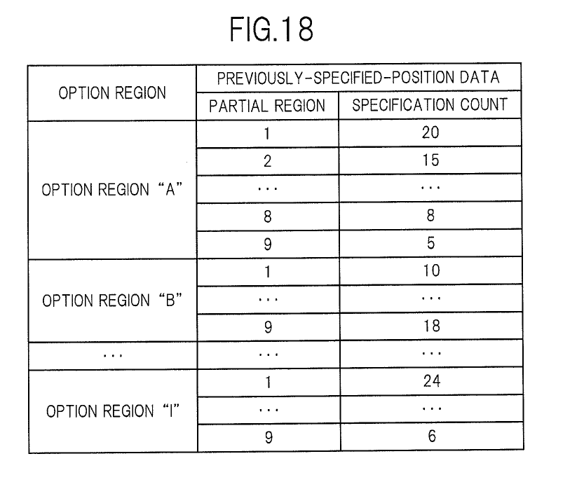

The recording section 92a records, in the previously-specified-position data storage section 84a, previously-specified-position data regarding a previously-specified position judged to be included in an option region 74a. FIG. 18 illustrates an example of contents stored in the previously-specified-position data storage section 84a.

Similarly to the character key region 74 of the first embodiment, a plurality of partial regions (for example, nine partial regions) are set in each option region 74a. In FIG. 18, a “partial region” indicates identification information (ID) of a partial region set in an option region 74a, and a “specification count” indicates a total number of times the player has specified a position in a partial region of an option region 74a, which is identified by the “option region” and the “partial region”. In other words, the “specification count” indicates a total number of times a position acquired by the specified-position acquiring section 86 has been judged to be included in the partial region of the option region 74a, which is identified by the “option region” and the “partial region”.

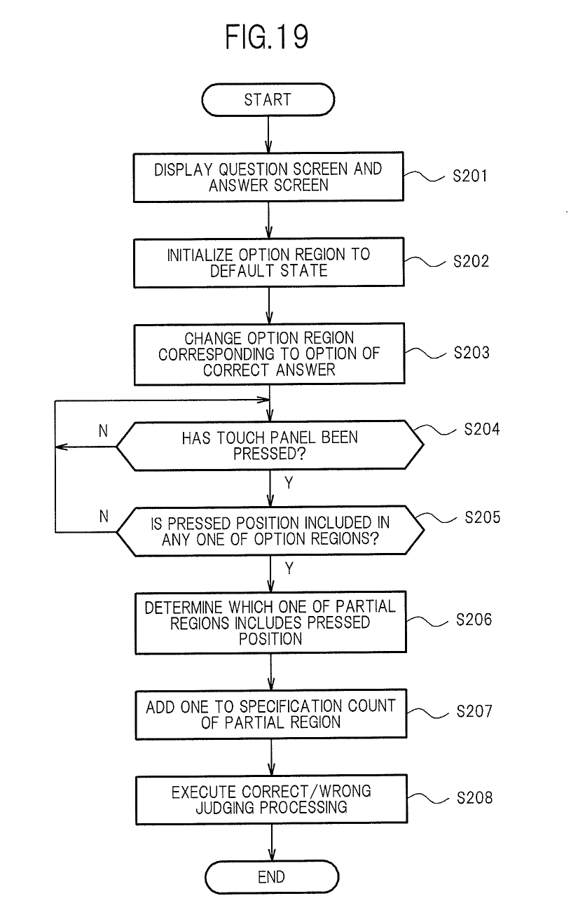

The reference region changing section 94a changes the option region 74a based on the previously-specified-position data. For example, the reference region changing section 94a changes the position, the area, the shape, or the like of the option region 74a. Detailed description is given later (see S203 of FIG. 19).

Next, description is given of processing to be executed by the game device 10 according to the second embodiment. FIG. 19 is a flow chart illustrating the processing to be executed by the game device 10. The microprocessor 44 executes the processing illustrated in FIG. 19 according to the program read from the game memory card 40.

As illustrated in FIG. 19, first, the microprocessor 44 displays a question screen on the second liquid crystal display unit 32, and displays the answer screen 60a on the touch screen 22 (S201). Further, the microprocessor 44 initializes each option region 74a to a default state (S202). The “default state” is, for example, the state illustrated in FIG. 16, that is, a state in which the regions showing the option images 64a coincide with the option regions 74a. In S202, the option region data corresponding to the default state is loaded from the game memory card 40 into the main memory 46.

Further, the microprocessor 44 (reference region changing section 94a) changes the option region 74a corresponding to the option of the correct answer (S203). In S203, first, change control data for the option region 74a is read from the game memory card 40. This change control data is data similar to the change control data of the first embodiment (see FIG. 12). After the change control data is read, the option region 74a corresponding to the option of the correct answer is changed based on the change control data. When the processing of S203 is finished, the option region data obtained after the option region 74a corresponding to the option of the correct answer is changed is stored in the main memory 46.

After that, the microprocessor 44 monitors whether or not the user has pressed the touch panel 22b (S204). In a case where the touch panel 22b has been pressed, the microprocessor 44 (specified-position acquiring section 86) acquires the pressed position as a position specified by the user. Then, the microprocessor 44 (judgment section 88a) judges whether or not the position specified by the user (pressed position) is included in any one of the option regions 74a based on the option region data stored in the main memory 46 (S205).

In a case where the position specified by the user is included in any one of the option regions 74a, the microprocessor 44 executes processing described below. First, the microprocessor 44 (recording section 92a) determines which one of the plurality of partial regions set in an option region X includes the position specified by the user (S206). Note that the “option region X” represents the option region 74a judged in S205 to include the position specified by the user. Then, the microprocessor 44 (recording section 92a) adds one to the specification count of a partial region Y in the previously-specified-position data (see FIG. 18) of the option region X (S207). Note that the “partial region Y” is the partial region judged in S206 to include the position specified by the user.

Further, the microprocessor 44 (execution section 90a) executes correct/wrong judging processing (S208). Specifically, in this case, it is determined that the user has selected the option corresponding to the option region X. Then, it is judged whether or not the option selected by the user matches the option of the correct answer. In a case where the option selected by the user matches the option of the correct answer, a point is added to the user's score. On the other hand, in a case where the option selected by the user does not match the option of the correct answer, no point is added to the user's score.

With the above-mentioned game device 10 according to the second embodiment, consideration is given to where the user tends to specify in each option region 74a, to thereby change the position of the option region 74a. According to the second embodiment, it becomes possible to allow the user to easily specify a position in an option region 74a. As a result, the operability can be improved for the user.

Further, with the game device 10 according to the second embodiment, the previously-specified-position data is recorded for each option region 74a, and hence, for each option region 74a, consideration is given to where the user tends to specify in the option region 74a, to thereby change the position of the option region 74a.

Further, with the game device 10 according to the second embodiment, only the option region 74a corresponding to the option of the correct answer is changed. If options other than the option of the correct answer are in a state of being easy for the user to select, the user is more likely to select an option other than the option of the correct answer by mistake. In this regard, according to the second embodiment, such inconvenience is prevented from occurring.

Further, with the game device 10 according to the second embodiment, only the position of the option region 74a which is invisible to the user is changed, and the position of the option image 64a which is visible to the user is not changed. Therefore, there is no possibility that it will become easier for the user to figure out the correct answer to the quiz. In other words, there is no influence on the degree of difficulty of the quiz.

Note that similarly to the case of the characters and the character groups of the first embodiment, an image corresponding to an option group to which a plurality of options belong (hereinbelow, referred to as “option group image”) maybe displayed in the answer screen 60a, instead of the option images 64a. Then, after the user has selected any one of the option groups, the option images 64a of the options belonging to that option group may be displayed on the answer screen 60a. In this modification example, regions corresponding to the respective option group images (hereinbelow, referred to as “option group regions”) are set on the answer screen 60a. Then, by judging whether or not the position specified by the user is included in anyone of the option group regions, it is judged whether or not the user has selected an option group. Further, based on a result of the judging, the option selected by the user (answer) is determined.

Further, in this modification example, similarly to the case of the option region 74a, a plurality of partial regions are set in the option group region. Then, for each option group region, the previously-specified-position data is stored. Further, in the processing of S203 of FIG. 19, the position of the option group region corresponding to the option group to which the option of the correct answer belongs is changed based on the previously-specified-position data. In this modification example, too, it is possible to improve the operability for the user.

### Modification Examples of First and Second Embodiments

Note that the present invention is not limited to the embodiments described above.

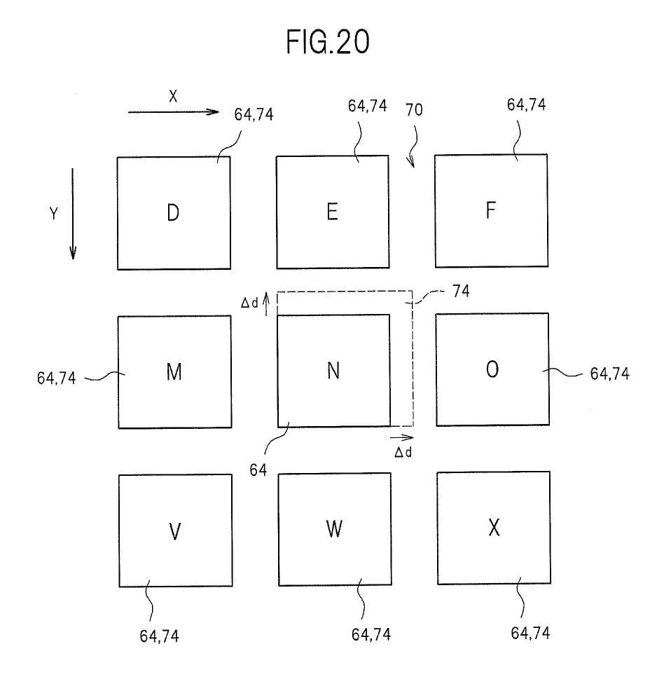

For example, in S107 of FIG. 9, based on the previously-specified-position data, the area of the character key region 74 may be made larger than an area in the default state. For example, the character key region 74 may be expanded rightward by the predetermined distance (Δd) and upward by the predetermined distance (Δd) as illustrated in FIG. 20, instead of, for example, shifting the character key region 74 rightward by the predetermined distance (Δd) and upward by the predetermined distance (Δd) as illustrated in FIG. 13. Similarly, in S203 of FIG. 19, the area of the option region 74a may be made larger than the area in the default state based on the previously-specified-position data.

Further, for example, in the first embodiment, in a case where the user's answer is incorrect, a string of the incorrect answer input by the user (hereinbelow, referred to as “incorrect answer string”) may be stored in the reference symbol sequence storage section 82 in association with the quiz question (or correct answer to the quiz). Then, the incorrect answer string may be considered to correspond to the “reference symbol sequence”. In other words, the character key region 74 may be changed based on the incorrect answer string. Specifically, in the processing of S106 of FIG. 9, it may be judged whether or not the string held in the string buffer matches a part from the beginning to the (i−1)-th character of the incorrect answer string stored in association with a currently-presented quiz question. Note that in a case where a plurality of incorrect answer strings are stored in association with the currently-presented quiz question, an incorrect answer string which has been input the largest number of times may be read from among the plurality of incorrect answer strings, and used in the processing of S106. Further, in the processing of S107 of FIG. 9, the character key region 74 corresponding to the i-th character of the incorrect answer string may be changed. In this manner, the user who is attempting to input an incorrect answer may also be allowed to input their answer smoothly. Then, as a result, the operability may be improved for the user.

Further, for example, in the second embodiment, in association with options other than the correct answer, information regarding how many times the respective options have been selected may be stored. Then, in the processing of S203 of FIG. 19, for example, of the options other than the correct answer, the option region 74a corresponding to an option which has been selected the largest number of times may be changed. In this case, of the options other than the correct answer, the option which has been selected the largest number of times corresponds to the “reference option”. In this manner, the user who is attempting to select an incorrect answer (option) may also be allowed to select the option smoothly. Then, as a result, the operability may be improved for the user.

Further, for example, operation means used by the user for specifying a position in the screen is not limited to the touch panel 22b, and may be, for example, a game controller, a mouse, or the like. For example, by displaying a cursor which moves according to an operation of the cross-shaped button 24c in the answer screen 60 or 60a, the user may also be allowed to specify a position on the answer screen 60 or 60a by using the cross-shaped button 24c.

Further, for example, the present invention is applicable to a game device 10 which executes a game other than the quiz game. Further, the present invention is also applicable to an information processing device other than the game device 10. The present invention is applicable to an information processing device which executes processing based on a result of comparison between a symbol sequence (for example, string) input by the user and a reference symbol sequence (for example, reference string). Then, according to the present invention, it becomes possible to allow the user who is attempting to input the reference symbol sequence to input the reference symbol sequence with greater ease. Further, the present invention is applicable to an information processing device which executes processing based on a result of comparison between an option selected by the user and a reference option. Then, according to the present invention, it becomes possible to allow the user who is attempting to select an option serving as the reference option to select the option with greater ease.

1. An information processing device, comprising:
specified-position acquiring means for acquiring a position specified by a user;
judgment means for judging whether or not the specified position is included in a reference region set on a screen;
execution means for executing processing based on a result of the judging made by the judgment means;
recording means for recording, in previously-specified-position data storage means, previously-specified-position data regarding a previously-specified position judged to be included in the reference region; and
reference region changing means for changing the reference region based on the previously-specified-position data.

2. The information processing device according to claim 1, wherein the previously-specified-position data comprises data regarding which one of a plurality of partial regions set in the reference region includes the previously-specified position.

3. The information processing device according to claim 1, wherein:
the judgment means judges whether or not the specified position is included in any one of a plurality of the reference regions set in the screen;
the previously-specified-position data is stored in association with a combination of reference regions;
the recording means updates, in a case where a second specified position is acquired after a first specified position is acquired, previously-specified-position data stored in association with a combination of a reference region including the first specified position and a reference region including the second specified position, based on the second specified position; and
the reference region changing means changes, in a case where a first reference region is changed, the first reference region based on previously-specified-position data stored in association with a combination of the first reference region and a second reference region including a specified position acquired immediately before.

4. The information processing device according to claim 1, further comprising reference symbol sequence storage means for storing a reference symbol sequence including one or a plurality of symbols, wherein:
a plurality of the reference regions each corresponding to a symbol or a symbol group are set in the screen;
the judgment means judges whether or not the specified position is included in any one of the plurality of the reference regions;
the execution means comprises means for determining, based on a result of the judging made by the judgment means, a symbol sequence input by the user; and
the reference region changing means changes, based on the previously-specified-position data, the reference region corresponding to a symbol included in the reference symbol sequence or the reference region corresponding to the symbol group to which a symbol included in the reference symbol sequence belongs.

5. The information processing device according to claim 4, wherein, in a case where the user inputs an i-th symbol (i: integer equal to or larger than 1), the reference region changing means changes, based on the previously-specified-position data, the reference region corresponding to the i-th symbol of the reference symbol sequence or the reference region corresponding to the symbol group to which the i-th symbol of the reference symbol sequence belongs.

6. The information processing device according to claim 1, further comprising reference option storage means for storing a reference option, wherein:
a plurality of the reference regions each corresponding to an option or an option group are set in the screen;
the judgment means judges whether or not the specified position is included in any one of the plurality of the reference regions;
the execution means comprises means for determining, based on a result of the judging made by the judgment means, an option selected by the user; and
the reference region changing means changes, based on the previously-specified-position data, the reference region corresponding to an option serving as the reference option or the reference region corresponding to the option group to which the option serving as the reference option belongs.

7. A method of controlling an information processing device, comprising:
a specified-position acquiring step of acquiring a position specified by a user;
a judgment step of judging whether or not the specified position is included in a reference region set on a screen;
an execution step of executing processing based on a result of the judging made in the judgment step;
a recording step of recording, in previously-specified-position data storage means, previously-specified-position data regarding a previously-specified position judged to be included in the reference region; and
a reference region changing step of changing the reference region based on the previously-specified-position data.

8. A program for causing a computer to function as:
specified-position acquiring means for acquiring a position specified by a user;
judgment means for judging whether or not the specified position is included in a reference region set on a screen;
execution means for executing processing based on a result of the judging made by the judgment means;
recording means for recording, in previously-specified-position data storage means, previously-specified-position data regarding a previously-specified position judged to be included in the reference region; and
reference region changing means for changing the reference region based on the previously-specified-position data.

9. A computer-readable information storage medium storing a program, the program causing a computer to function as:
specified-position acquiring means for acquiring a position specified by a user;
judgment means for judging whether or not the specified position is included in a reference region set on a screen;
execution means for executing processing based on a result of the judging made by the judgment means;
recording means for recording, in previously-specified-position data storage means, previously-specified-position data regarding a previously-specified position judged to be included in the reference region; and
reference region changing means for changing the reference region based on the previously-specified-position data.
